(19) United States
(12) Patent Application Publication
(10) Pub. No.: US 2026/0060261 A1
(43) Pub. Date: Mar. 5, 2026

(54) ANTIMICROBIAL COMPOSITIONS AND METHODS OF USE THEREOF

(71) Applicant: Harshavardhan Thippareddi, Athens, GA (US)

(72) Inventor: Harshavardhan Thippareddi, Athens, GA (US)

(21) Appl. No.: 19/311,899

(22) Filed: Aug. 27, 2025

Related U.S. Application Data
(60) Provisional application No. 63/688,158, filed on Aug. 28, 2024.

(51) Int. Cl. A23B 4/12; A23B 4/22; A23B 7/10; A23B 7/155

(52) U.S. Cl. CPC A23B 4/12; A23B 4/22; A23B 7/10; A23B 7/155

(57) ABSTRACT

Compositions and methods for inhibiting microbial growth and/or accelerating fermentation in meat and other food products using acyl glycerol compounds are provided. The acyl glycerol compounds are added to food products in their natural oil form, via various routes of administration (mix, dip, spray, etc.). The acyl glycerol esterification sites can be tailored and/or mixtures of different acyl glycerol compounds may be used. The acyl glycerol compounds can also be used in combination with one or more additional agents, for example as part of a multi-functional antimicrobial or carrier of antioxidants, flavor compounds, etc.

### RELATED APPLICATIONS

This application claims the benefit of U.S. Provisional Application No. 63/688,158, filed Aug. 28, 2024, which is incorporated by reference herein in its entirety.

### BACKGROUND

Acids such as acetic acid, propionic acid, lactic acid and others have been used in the food industry as antimicrobials. However, they can, for example, denature the proteins in meat and meat products, thus altering the nature of the product and negatively impacting the quality of the meat product. In addition, they do not provide residual antimicrobial activity.

Antimicrobial compositions that can avoid such drawbacks and provide continued activity, which can limit growth of spoilage microorganisms as well as foodborne pathogens and provide significant improvement in shelf life as well as microbial safety, are needed in the industry.

### SUMMARY

The present invention provides, in various embodiments, compositions and methods for inhibiting microbial growth and/or accelerating fermentation using acyl glycerol compounds. The acyl glycerol compounds can be added to food products in their natural oil form, which is neutral and inactive, only releasing/providing their component acids when needed or “on demand”—for example, when foodborne microorganisms grow over time in the food products and/or when triggered by an added enzyme such as a lipase.

In some embodiments, the invention provides a method of inhibiting growth of foodborne microorganisms in a food product, comprising adding to the food product an acyl glycerol comprising one or more short chain fatty acids having antimicrobial activity, wherein the method provides free forms of said acids in the food product on demand, responsive to the growth of the microorganisms in the food product.

In some embodiments, at least one of the short chain fatty acids is selected from the group consisting of formic acid, acetic acid, propionic acid, lactic acid, butyric acid, iso-butyric acid, valeric acid, iso-valeric acid, and 2-methylbutyric acid.

In some embodiments, at least one of the short chain fatty acids is benzoic acid, sorbic acid, or citric acid.

In some embodiments, the acyl glycerol is a triacyl glycerol (TAG).

In some embodiments, the acyl glycerol is triacetin, diacetin, or monoacetin.

In some embodiments, a concentration of the acyl glycerol is about 0.05% to about 5% by weight of the food product.

In some embodiments, a concentration of the acyl glycerol is about 0.5% to about 2% by weight of the food product.

In some embodiments, the acyl glycerol is added to the food product as a spray.

In some embodiments, the acyl glycerol is added to the food product in combination with one or more additional agents.

In some embodiments, the one or more additional agents comprise one or more bactericidal antimicrobials, bacteriostatic antimicrobials, anti-mycotics, acidifiers, bacteriocins, antioxidants, chelating agents, antifoam agents, emulsifiers, or flavoring agents.

In some embodiments, the bactericidal antimicrobials are selected from the group consisting of organic acids, PAA, ASC, ACS, and LAE; the bacteriostatic antimicrobials are selected from the group consisting of sodium or potassium salts of organic acids, and hops acids; the organic acids comprise formic, acetic, propionic, citric, and lactic acids; and the antioxidants are selected from the group consisting of BHA, BHT, TBHQ, PG, rosemary extract, tocopherols and Vitamin E extracts, ascorbic acid, plant derived polyphenols, liquid smoke, and liquid smoke extracts and fractions.

In some embodiments, the microorganisms comprise at least one of spoilage bacteria, pathogenic bacteria, molds, and yeasts.

In some embodiments, the acyl glycerol comprises at least two different short chain fatty acids.

In some embodiments, the acyl glycerol comprises a mixture of two or more different acyl glycerols.

In some embodiments, the acyl glycerol comprises triacetin in combination with tripropionin.

In some embodiments, the method further comprises adding to the food product an enzyme capable of releasing the free forms of said acids.

In some embodiments, the food product comprises a meat product.

In some embodiments, the food product comprises fresh fruit.

In some embodiments, the invention provides a method of accelerating fermentation in a food product, comprising adding to the food product an acyl glycerol comprising one or more short chain fatty acids having antimicrobial activity; and adding to the food product a fermentation starter culture, wherein the method provides free forms of said acids in the food product as the acyl glycerol breaks down, thereby reducing time to reach a target pH as compared to a control without the acyl glycerol added.

In some embodiments, the food product comprises a dairy product, a vegetable product, a cereal product, or a meat product.

In some embodiments, the invention provides a composition for inhibiting growth of foodborne microorganisms and/or accelerating fermentation in a food product, the composition comprising an acyl glycerol comprising two or more different short chain fatty acids having antimicrobial activity.

In some embodiments, the invention provides a composition for inhibiting growth of foodborne microorganisms and/or accelerating fermentation in a food product, the composition comprising a mixture of two or more different acyl glycerols, each acyl glycerol comprising one or more short chain fatty acids having antimicrobial activity.

Additional features and advantages of embodiments of the present invention are described further below. This summary section is meant merely to illustrate certain features of embodiments of the invention and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of certain embodiments of the application, will be better understood when read in conjunction with the appended drawings. For the purposes of illustrating the systems and methods of the present application, there are shown in the drawings certain embodiments. It should be understood, however, that the application is not limited to the precise arrangements and instrumentalities shown. In the drawings:

FIG. 1 shows pH of ground beef (control) and ground beef containing 1% and 2% triacetin immediately after addition and after 48 h of temperature abuse (continuous cycling of temperature between 1° and 40° C. within 6 h for 60 h);

FIG. 2 shows total microbial population (aerobic plate count [APC], log CFU/g) of ground beef (control) and ground beef containing 1% and 2% triacetin immediately after addition and after 48 h of temperature abuse (continuous cycling of temperature between 1° and 40° C. within 6 h for 60 h);

FIG. 3 shows microbiological quality (aerobic plate count; APC) of ground beef containing triacetin during refrigerated storage at 45° F.;

FIG. 4 shows microbiological quality (APC) of ground pork containing triacetin during refrigerated storage at 45° F.;

FIG. 5 shows microbiological quality (APC) of ground chicken containing triacetin during refrigerated storage at 45° F.;

FIG. 6 shows destruction of Salmonella in ground pork containing triacetin during continuously varying temperatures;

FIG. 7 shows destruction of Salmonella in ground chicken containing triacetin during continuously varying temperatures;

FIG. 8 shows pH decline in meat batter containing triacetin during fermentation at 32° C.;

FIGS. 9A-C show (A) a strawberry obtained from a retail supermarket that contains mold, (B) the strawberry from panel A with mold rinsed off and triacetin spray applied, and (C) the strawberry from panel B after storage at 21° C. for 4 days;

FIG. 10A shows ripe strawberries obtained from a retail supermarket (no triacetin);

FIG. 10B shows ripe strawberries obtained from a retail supermarket and sprayed with triacetin;

FIG. 11A shows ripe strawberries obtained from a retail supermarket and stored at 21° C. for 4 days (no triacetin);

FIG. 11B shows ripe strawberries obtained from a retail supermarket, sprayed with triacetin, and stored at 21° C. for 4 days;

FIG. 12 shows GC-FID (gas chromatography with flame ionization detection) analysis results for mixed short-chain triglyceride samples;

FIG. 13 shows control of APCs in ground turkey containing triacetin (TA), tripropionin (TP), and mixtures thereof during continuously varying temperatures; and

FIG. 14 shows control of Salmonella in ground turkey containing triacetin (TA), tripropionin (TP), and mixtures thereof during continuously varying temperatures.

### DETAILED DESCRIPTION

Lipids are a heterogeneous group of biological compounds almost insoluble in water but soluble in fats, hydrocarbon type and other fat solvents. Fats and oils are example of lipids and are composed largely of triglycerides with great importance in food systems, and they are formed by esters of a molecule of glycerol and three fatty acid molecules.

Fats and oils (see, e.g., Table 1) are important ingredients in a variety of foods. The fats and oils contribute several desirable characteristics to the foods such as tenderness to shortened cake, and by aerating batter, fats aid in establishing texture in cakes; they also add flavor to foods and influence the order in which components of flavor are released when foods are eaten, besides having a lubricating effect and producing a sensation of moistness in the mouth. They also serve as a medium for transferring heat to foods such as in deep frying and other applications.

Dietary triacylglycerols (TAGs) are the major lipid and/or oil components in the human diet and they are carriers of energy as well as nutritionally important fatty acids. The fats in the human diet constitute about 40% of the energy intake in the Western world. The most important lipid component in the human diet is triacylglycerol (TAG), which may amount to 100 g per day or more in vigorous physical activity. The diet contains phospholipids, about 5 g per day, and minor contents of glycolipids, sterols, and vitamins D, E, A, and K in addition to the TAG. The digestive system can digest the TAGs and absorb them with more than 95% efficiency under normal circumstances.

The TAG molecule consists of a glycerol backbone to which are acylated three fatty acids. The positions are numbered by the stereochemical numbering system: fatty acids may be designated sn1-, sn2- and sn3-. The formula below shows the stereochemistry of triacylglycerol structure, where R1, R2, and R3 are the fatty acids acylated to the sn1-, sn2-, and sn3-positions, respectively, according to the stereochemical nomenclature.

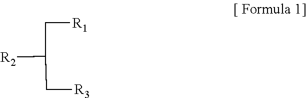

In most TAG molecules the fatty acids in the sn1-position and in the sn3-position will be different and there will therefore exist two possible enantiomeric TAGs with similar fatty acid profiles and the same fatty acid located in the sn2-position. This disclosure uses a short hand notation, e.g., 16:0/18:2/18:1 for 1-palmitoyl-2-linoleyl-3-oleyl-sn-glycerol, but also for TAGs analyzed by regiospecific methods that do not distinguish between sn1- and sn3-positions.

Fatty acids in foods may vary in chain length from C8 to C24 and from saturated fatty acids to unsaturated fatty acids with up to six or more double bonds. The possible number of different TAGs including enantiomers is n³, where n is the number of fatty acids present, and will be very large for a fat containing even a limited number of fatty acids. With just 10 different fatty acids the total number of individual TAG molecules will thus amount to 1,000.

TABLE 1
Composition of some natural fats and oils^{a, b}

| | |
|---|---|
| Fat or oil | Major TAGs |

| | | | |
|---|---|---|---|
| Butter fat | PPB | PPC | POP |
| Horse fat | OOO | POO | LOO |
| Lard | SPO | OPL | OPO |
| Tallow (beef) | POO | POP | POS |
| Cocoa butter | POS | SOS | POP |
| Coconut oil | DDD | CDD | CDM |
| Palm kernel oil | DDD | MOD | ODO |
| Almond oil | OOO | OLO | OLL |
| Corn oil | LLL | LOL | LLP |
| Cottonseed oil | PLL | POL | LLL |
| Egg TAG | POO | PLO | POS |
| Grapeseed oil | LLL | OLL | POL |
| Hazelnut oil | OOO | OLO | POO |
| Olive oil | OOO | OOP | OLO |
| Palm oil | POP | POO | POL |
| Peanut oil | OOL | POL | OLL |
| Rice bran oil | PLO | OOL | POO |
| Safflower oil | LLL | LLO | LLP |
| Soybean oil | LLL | LLO | LLP |
| Sunflower oil | LLL | OLL | LOO |
| Walnut oil | LLL | OLL | PLL |
| Rapeseed oil (low Er) | OOO | LOO | OOLn |
| Rapeseed oil (high Er) | ErOEr | ErLEr | ReLnEr |
| Linseed oil | LnLnLn | LnLnL | LnLnO |
| Mustard seed oil | ErOEr | ErLEr | OOEr |

^{a}Abbreviations used for acyl chains in the triacylglycerols (TAGs): B, butyric; C, capric; D, dodecanoic; M, myristic; P, palmitic; S, stearic; O, oleic; E, elaidic; L, linoleic; Ln, linolenic; G, gogoleic; Er, erucic
^{b}Mu and Hoy, 2004 (Progress in Lipid Research 43(2): 105-133)

The majority of the fatty acids within the naturally occurring TAGs in food ingredients or foods consist of fatty acids of chain length greater than 8 (caprylic acid) and may contain fatty acids of up to 22 carbons (behenic acid).

Triacyl glycerols with short chain fatty acids such as acetic, propionic, butyric, iso-butyric, valeric, iso-valeric and 2-methylbutyric do not exist in nature. However, they can be synthesized by transesterification of glycerol with the respective short chain fatty acids. Acetins, also called glycerol acetates, exist in three forms: monoacetin (glycerol monoacetate), diacetin (glycerol diacetate), and triacetin (glycerol triacetate). The acetin form given is dependent on the number of the hydroxyl group of glycerol substituted with the acetyl group. Monoacetin and diacetin typically exist in two isomeric forms: 1-monoacetin and 2-monoacetin and, similarly, 1,2-diacetin and 1,3-diacetin. Acetins have garnered the most interest among the glycerol derivatives because of their extensive commercial applications. In the present description, the term “triacetin” will be used to represent all forms of acetins/glycerol acetates—triacetin, diacetin and monoacetin—going forward.

Triacetin, also known as glyceryl triacetate or simply acetylated glycerin has a long-standing history in food science, and serves various existing purposes in the food industry, as described below.

Chemically, triacetin is an ester derived from glycerol and acetic acid, characterized by its ability to dissolve both water-insoluble and water-soluble compounds. This unique attribute underpins its efficacy as a solvent, emulsifier, and stabilizer in food formulations.

The unique physiochemical properties of acetins, such as stability, biodegradability, and water miscibility, make them attractive for industrial applications. They are used as plasticizers, emulsifiers, stabilizers, solvents, space foods, cosmetics, pharmaceuticals, medicines, food additives, humectants, and vehicles for drug delivery systems. They are also used as biofuel additives to improve viscosity and cold flow properties. Monoacetin is used as a tanning agent in leather and to produce explosives and smokeless powders. Diacetin is used as a solvent for various dyes. Among the three products, triacetin is considered the most valuable and has been widely used in various applications. Therefore, the price of triacetin is comparatively high and stable, with demand growing by 5-10% yearly.

Triacetin finds widespread applications in the food industry, primarily as a humectant, solvent, and emulsifier. Its humectant properties make it a valuable additive in confectionery, bakery, and dairy products, preventing moisture loss and prolonging shelf life. Furthermore, triacetin's emulsifying capabilities render it indispensable in salad dressings, margarine, and ice cream, ensuring homogeneous dispersion of fat and water phases. Additionally, its solvent properties facilitate the incorporation of flavors, colors, and vitamins into food formulations, enhancing sensory attributes and nutritional value.

The U.S. Code of Federal Regulations (CFR 2024) cites the use of triacetin as a flavoring agent and adjuvant, a formulation aid and humectant, a solvent in foods such as alcoholic beverages, non-alcoholic beverages, beverage bases, chewing gum, confections and frostings, frozen dairy desserts and mixes, gelatins, puddings and fillings, hard candy and soft candy.

The U.S. Food and Drug Administration (FDA) has deemed triacetin as Generally Recognized as Safe (GRAS) for its intended use in food products, provided it complies with specified purity criteria (CFR 2024).

The present inventor has unexpectedly found that triacetin, related acyl glycerols (monoacetin and diacetin) and other glycerol-based products with fatty acids (propionic, lactic and others), benzoic and sorbic acids can act as on-demand antimicrobials in foods.

The major advantage of triacetin and related glycerated products is their inert nature in their natural form, as an oil. Over time (i.e., when needed or “on-demand” responsive to microbial growth over time), the breakdown products of the acyl glycerols such as acetic acid, propionic acid, benzoic acid, sorbic acid and/or lactic acid are released and exhibit their antimicrobial function when microbial activity increases or microbial growth occurs. As such, these inert ingredients can be added to foods without any consequence to the food properties of the products they are added to. An example is the use of triacetin in ground beef, ground pork (sausage) or ground chicken production, where addition of triacetin will not cause any adverse issues, while direct addition of the component antimicrobials (acetic acid, propionic acid, lactic acid and others) can denature the proteins in the meat and meat products, thus altering the nature of the product and negatively impacting the quality of the ground meat product.

In some embodiments, the antimicrobial activity of the acyl glycerol can additionally/alternatively be activated by adding an enzyme to the acyl glycerol (oil) to release the component organic acid (antimicrobial) at a desired rate. This can be achieved by formulating/adjusting the acyl glycerol to enzyme ratio to match the desired rate of release of the antimicrobial. Examples of suitable trigger enzymes include, but are not limited to, lipases derived from plant, animal and/or microbial (including bacteria, yeasts and/or mold) sources.

Further, these mono, di or triacyl glycerols can be used in combination with other antimicrobials as multi-functional ingredients such as a carrier for flavors and antioxidants (rosemary and similar products), as surface treatments such as on fresh fruits to prevent or inhibit bacterial and mold spoilage, and other potential applications.

Examples of specific triacetin uses include, but are not limited to:
In and/or on meat and/or other food products as an ingredient to inhibit microbial growth through on-demand release of acetic acid or other short chain fatty acids (propionic acid, lactic acid, etc.) or other antimicrobial compounds such as benzoic acid, sorbic acid, etc. to inhibit foodborne microorganisms, both spoilage as well as pathogenic bacteria, molds and/or yeasts.
As a spray on fresh fruit to inhibit spoilage due to mold growth and other bacterial rot.
As part of antimicrobial such as peroxyacetic acid (also known as peracetic acid or PAA) to enhance its use as an antimicrobial (bactericidal) as well as a microbial inhibitor (bacteriostat) to extend shelf life of food products.
As a carrier of antioxidants and other flavor compounds as multi-functional ingredient in food products to inhibit oxidation of foods (extend chemical shelf life—contributed by the antioxidant) as well as extend microbial shelf life of foods (through microbial inhibition); e.g., as a carrier for rosemary or similar antioxidants for use in meat products such as ground beef to inhibit oxidation (chemical shelf life) and microbial growth (microbial shelf life).
As an ingredient in accelerating fermentation of meat or other food products, where food acids can be released from the glycerated products such as glyceryl lactates (mono, di or tri) due to microbial activity from bacterial cultures, thus accelerating the fermentation process and reducing the time of fermentation.

As noted above, triacetin, by nature is an oil, similar to other oils where the glycerol molecule is esterified with different fatty acids. In nature, these fatty acids can be caprylic, capric, lauric, myristic, palmitic, stearic, arachidic, behenic, lignoceric or cerotic acids esterified to the glycerol molecule to make an oil or a fat. The type of fatty acid and the numbers attached to the glycerol molecule dictate whether the final product is an oil (liquid) or a fat (solid).

Triacetin also can be dissolved or mixed with water (up to 6%) based on the temperature and this flexibility of being an oil and the ability to mix with water with minimal separation (as when oil is mixed with water) provides an excellent functionality to the triacetin. Thus, triacetin can be combined with other antimicrobials or other functional agents, regardless of whether those functional agents are water soluble or oil soluble. For example, the antimicrobial peroxy acetic acid (PAA) is extensively used as a solution in water for decontamination of poultry carcasses and other meat animal carcasses (beef, pork, etc.) or their parts and is applied as a spray or a dip. Triacetin can be combined with this PAA solution for application on the poultry carcasses or the other meat animal carcasses. Addition of triacetin to the PAA solution and subsequent application allows for immediate reduction in microbial numbers (bacteria, yeast or mold) through the bactericidal action of PAA and provides further protection from growth of these microorganisms during further processing storage of the products. In addition, combining triacetin with PAA solution provides protection from growth of the microorganisms (which can be foodborne pathogens such as Salmonella, Campylobacter, Escherichia coli O157:H7 and other Shiga toxin-producing E. coli [STEC], Listeria monocytogenes and other microorganisms) in case there is temperature abuse of the products during further processing or during distribution, storage and display of meat and poultry products.

Being an oil that can be dissolved in water, triacetin can be used as a carrier of other functional agents of foods such as antioxidants (natural or synthetic), flavors, acidifiers, bacteriocins, chelating agents, and anti-foaming agents used in food production/processing.

In addition to its individual use, triacetin can also be provided in combination with other bactericidal agents. A list of antimicrobials (bactericidal and bacteriostatic) that the triacetin can be used in combination with is shown in Table 2. The amount of triacetin used will be based on the needed concentration for the triacetin for the specific function in the finished product.

For example, in a ground chicken product, if the need is to control the spoilage microflora as well as foodborne pathogens such as Salmonella, Campylobacter and others, the use level/concentration of triacetin in the finished product can be anywhere from 0.05 to 5% by weight of the finished food product and beyond based on the need to control the microbial growth. However, if it is used as a surface spray to control surface growth of microorganisms such as in a hotdog or similar processed products where the microorganisms are on the surface of the product, the use level can be 0.05 to 1% by weight of the finished food product. The use level is based on the application.

When combined with other antimicrobials or functional agents, the proportion of the mixture should be based on the final concentration to be delivered in the finished food product. For example, if the final desired concentration of peroxy acetic acid (PAA) is 1,000 ppm and the final desired concentration of triacetin is 1% by weight of the finished food product, these can be mixed in that proportion (1:10—PAA:triacetin) and delivered to the finished product as a solution in water at the desired use level.

The final use concentration of triacetin can range from 0.05% up to 5% and beyond. Triacetin is a Generally Recognized as Safe (GRAS) substance by US Food and Drug Administration and as such does not have an upper limit for use in food products. This upper limit is dictated by the changes to product characteristics (e.g., texture, flavor, etc.) that inclusion of triacetin causes. In various embodiments, the ranges for use of acyl glycerols can be, for example, from 0.05% to 5% depending on the target final pH of the product, time to fermentation and the desired quality of the product.

In the experiments described herein, a standard concentration of ≥1.0% of triacetin was used. This concentration provided significant inhibition in microbial load, including general microbial populations (shelf life) as well as foodborne pathogen (Salmonella spp.). However, in most cases, food processors may not require this substantial extension in microbial shelf life (from inhibition of general microbial populations) and consequently, foodborne pathogen inhibition. For example, addition of triacetin at 1.0% in ground chicken reduced general microorganisms (APCs) by 0.44 log CFU/g on day 14 during abusive refrigerated storage at 7.2° C. Traditional shelf life of ground chicken is around 7 to 10 days at a much lower storage temperature of 1.7° C. In this study, microbial growth was prevented during storage at (i) relatively high and abusive storage temperature of 7.2° C. and (ii) for longer period (14 days) resulting from the addition of triacetin (1.0%) compared to normal procedures used in transportation and storage of ground chicken.

While use of triacetin at 1.0% was able to prevent microbial growth, other indicators of shelf life such as chemical changes in the meat as well as the changes in the color may preclude the use of meat after such extended storage. In such cases, lower concentrations, at or above 0.05% of triacetin may still provide adequate microbial shelf life that corresponds to other meat characteristics such as color for marketing purposes (sale to the consumer).

Table 2 also includes examples of antioxidants that can be combined with triacetin for delivery into the food products. These include synthetic antioxidants BHA, BHT, TBHQ and PG as well as naturally derived antioxidants such as rosemary extract, tocopherols and Vitamin E extracts, ascorbic acid, plant derived polyphenols, liquid smoke and liquid smoke extracts and fractions among others.

As described above, the proportion and the concentrations of the antioxidant and triacetin mixture will depend on the end use in the food product and the desired concentrations in the finished product. The use levels described above can be followed.

TABLE 2
Triacetin and acyl-glycerols as multi-functional agents
Food Ingredients

Bactericidal antimicrobials
Organic acids (formic, acetic, propionic, citric, lactic)
Peroxy Acetic Acid (PAA)
Acidified sodium chlorite (ASC)
Acidic calcium sulfate (ACS)
Lauramide arginine ester (LAE)
Bacteriostatic antimicrobials
Sodium or potassium salts of organic acids (formic,
acetic, propionic, citric and lactic)
Hops acids
Anti-mycotics (anti-mold)
Propionic acid or sodium or potassium propionates
Sorbic acid or sodium or potassium sorbates
Benzoic acid or sodium or potassium benzoates
Acidifiers
Gluconic acid
Malic acid
Glucono delta lactone (GDL)
Bacteriocins (antimicrobial peptides - bacteria derived)
Nisin
Natamycin
Antioxidants - synthetic
BHA (butylated hydroxy anisole)
BHT (butylated hydorxy toluene)
TBHQ (tertiary butylated hydroxy quinolone)
PG (propyl gallate)
Antioxidants - natural
Rosemary extract
Tocopherols and Vitamin E extracts
Ascorbic acid
Polyphenols
Liquid smoke and liquid smoke extracts
Chelating agents
Citric acid
Malic acid
Tartaric acid
Oxalic acid
Succinic acid
Antifoam agents
Glycols - Propylene glycol, Polysorbate
Silicones - polydimethylsiloxanes (PDMSs),
fluorosilicones, and organo-modified silicones
Alcohols - cetostearyl alcohol
Stearates
Polyacrylates
Emulsifiers
Mono or diglycerides
Lecithin
Sucrose esters and sucroglycerides
Polyglycerol polyricinoleate
Sorbitan esters
Polysorbates
Flavoring agents
Essential and spice oils

In addition, triacyl glycerol can be tailored for a desired one of the above-identified uses. The glycerol molecule contains three binding sites for the esterification—1, 2 and 3 as shown in the formula below. Any and all of the three can be esterified with specific organic acids. For example, if the desired function is to control bacterial spoilage and also spoilage due to mold growth, one or two of the binding sites can be used to esterify with propionic acid, benzoic acid or sorbic acid. This “tailoring” allows for developing and delivering specific functionality (in this case, both bacterial as well as mold growth and spoilage).

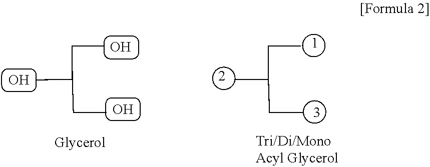

The esterification sites 1, 2 and 3 can be selectively esterified with any of the acids, including the organic acids (formic, acetic, propionic, lactic, etc.) or other acids (sorbic, benzoic, etc.) at any and all esterification sites (1, 2 and/or 3) to tailor the triacyl glycerol to specific purpose or application (e.g., to control bacterial and/or mold growth).

Alternatively, different tri-, di-, and/or mono-acyl glycerols can be combined in a mixture having each acyl glycerol type present in a desired amount for the specific application. For example, triacetin can be combined at desired proportions with tripropionin (glycerol esterified with three molecules of propionic acid) or other acyl glycerols. The proportions of the mixtures and the specific contents of the mixtures will depend on the desired functionality and also the proportions and concentrations desired or required in the finished product for the functionality.

As consumer demand for natural and clean-label ingredients continues to rise, the food industry is faced with the challenge of reconciling technological advancements with consumer preferences. In this context, alternative preservatives and additives derived from natural sources are desirable. Accordingly, compositions and methods using botanical extracts and/or bioactive compounds that can function as substitutes for synthetic additives like triacetin are specifically contemplated, thereby aligning embodiments of the present invention with evolving consumer preferences while ensuring food safety and quality.

### EXAMPLES

### Example 1

Shelf life of ground products such as ground beef is limited due to relatively high microbial load of the product immediately after grinding and subsequent microbial growth during refrigerated storage. Meat processors employ a variety of antimicrobials such as organic acids (lactic acid, citric acid and combinations with mineral acids) to reduce populations of foodborne pathogens in case they are present. While the population of general microbial spoilage microorganisms is reduced as well, this does not result in significant improvement in shelf life of the product as the traditional antimicrobials do not provide residual antimicrobial activity.

Antimicrobials that can provide such continued activity can limit growth of spoilage microorganisms as well as foodborne pathogens and can provide significant improvement in shelf life as well as microbial safety.

This Example shows the efficacy of triacetin (glyceryl triacetate) in inhibiting spoilage microorganisms in ground beef and thereby improving its shelf life.

Ground beef was obtained from a retail store and stored refrigerated until use. Triacetin (Acros Organics, Fairlawn, NJ) was added to 100 g of ground beef at 1% and 2% concentrations and mixed manually, along with a no-treatment control. An aliquot of ground beef (7 g) was transferred into vacuum pouches, measuring 6.35 by 12.7 cm (2.5 in.×5 in.) (Prime Source, Kansas City, Mo., U.S.A.), vacuum sealed at 1.2 kPa using a vacuum-packaging machine (A300/H, Multivac, Wolfertschwenden, Germany), and placed in a programmable water bath (APR15R-40-A11B; Polyscience, Niles, IL). The water bath was programmed to continuously cycle between 1° and 40° C. in 5 h, for 60 h to evaluate inhibition of microbial growth by triacetin in ground beef.

A pouch was removed at 0, 12, 24, 36 and 48 h intervals and microbial populations was enumerated by initially diluting (1:10) in buffered peptone water (BPW) and then, serially in sterile peptone water (0.1%; PW). The serial dilutions were plated on Petrifilm Aerobic Plate Count (APC) plates, incubated at 35° C. for 48 h and enumerated. The microbial populations were expressed as log CFU/g.

The pH of the meat was determined using the initial dilution (BPW) using a pH meter (pHTestr 30; Oakton, Vernon Hills, IL) in product at 0 h and 48 h.

Three independent replications were performed with different ground beef obtained for each replication.

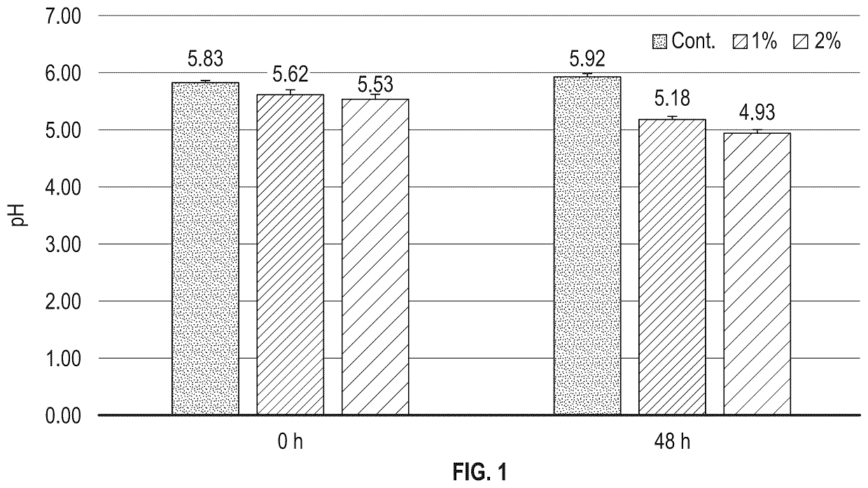

Addition of triacetin (1% and 2%) resulted in a pH decrease to 5.62 and 5.53, respectively from an initial pH of 5.83 in Control ground beef (FIG. 1). Subsequent to 48 h of temperature fluctuation and microbial growth, the pH of Control and ground beef containing 1% and 2% triacetin was 5.92, 5.18 and 4.93, respectively. During microbial growth, the produced lipases hydrolyze the triacetin to produce glycerol and acetic acid, reducing product pH.

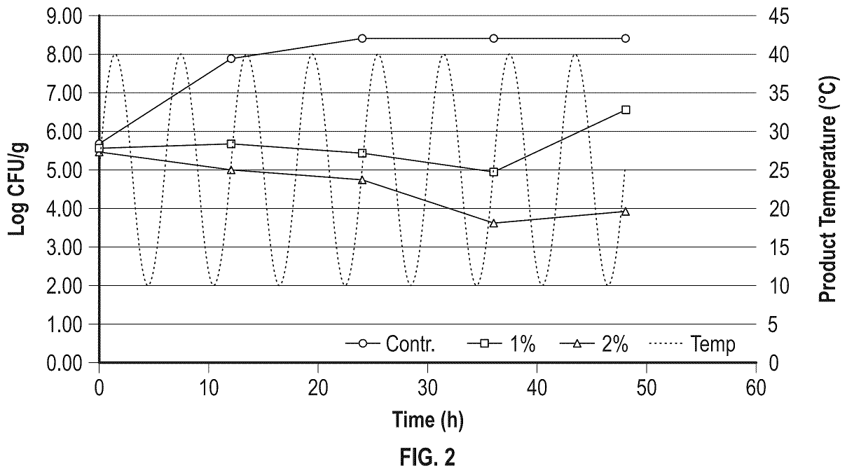

Initial microbial population of ground beef was 5.63, 5.54 and 5.46 log CFU/g in control ground beef, and ground beef containing 1% and 2% triacetin, respectively (FIG. 2). Cycling ground beef temperature between 1° and 40° C. within 6 h continuously resulted in an increase in microbial population of ground beef to 7.88, 8.43, 8.43 and 8.44 log CFU/g after 12, 24, 36 and 48 h, respectively. Addition of triacetin (1%) resulted in bacteriostatic activity, with microbial population of 5.65, 5.42, 4.93 and 6.59 log CFU/g after 12, 24, 36 and 48 h, respectively. Increasing the triacetin concentration to 2% in ground beef resulted in gradual decline in microbial population to 5.00, 4.74, 3.65 and 3.93 log CFU/g after 12, 24, 36 and 48 h, respectively. While a reduction in microbial population was observed in ground beef subsequent to temperature fluctuation (abuse), the concomitant decrease in pH of ground beef may not be acceptable in ground beef. However, adequate control in growth of spoilage flora was observed at 1% triacetin concentration, with a minimal decline in ground beef pH (50 5.18 after 48 h).

Triacetin addition to ground beef resulted in inhibition of spoilage microflora growth, with 2.25 log CFU/g growth in ground beef (control) and minimal growth (0.02 log CFU/g) observed in ground beef containing 1% triacetin subsequent to 12 h of temperature abuse. Optimizing the triacetin concentration for addition to ground beef can achieve adequate extension in shelf life with minimal reduction in ground beef pH, an undesirable quality change.

### Example 2

The efficacy of acyl glycerol use as a surface treatment of fruits to mitigate bacterial and/or mold growth and spoilage may be determined by the following method.

Surface inoculated fruit (strawberry, peach, or similar fruit) is placed on a conveyor. The inoculated fruit drops from the conveyor onto another conveyor about 100 cm below the first conveyor. While the fruit is dropping from the first conveyor to the second conveyor, the acyl glycerol-containing antimicrobial is sprayed by a mist sprayer or an electrostatic device as a fine mist to cover the entire surface of the fruit. The spray volume, mist droplet size and the concentration of the antimicrobial are adjusted to deliver the specified amount of antimicrobial on to the fruit surface. The surface treated fruit is collected and packaged as normal fruit on a tray and covered with a saran wrap or a similar film. The product (fruit) is stored at different temperatures for various periods of time and the potential growth of microorganisms (bacteria, mold, etc.) is monitored visually or through other microbiological methods.

### Example 3

In some embodiments, acyl glycerol may be used to enhance fermentation processes (e.g., fermented sausages, fermented dairy products such as yogurt, etc.).

Microencapsulation of food ingredients was introduced in the late 1960s and today a variety of encapsulated products (e.g., acids, flavors, antioxidants) are available to the meat processor. Encapsulated acids are used to help address the problem of fast acid release. One of the advantages of using encapsulated acids over lactic acid bacteria (LAB) is shortened processing time (i.e., skipping the 8- to 24-h fermentation period), thus increasing plant throughput. However, numerous meat processors still use bacterial cultures because of the unique contribution of LAB lipases and protease to the product's flavor profile and aroma.

However, encapsulation is an expensive process and encapsulation of organic acids such as citric and lactic acids, which are traditionally used in fermented meat processing in some cases can be cost-prohibitive. Further, encapsulation is traditionally done using fats so they are in the dry form and to release the acid, these fats have to be melted and is done using heat. The product temperature is gradually increased to melt the fat and release the acid. However, this heat treatment may affect product (e.g., sausage) quality. Use or incorporation of triacetin and similar acyl glycerols has the added advantage that they can be easily incorporated into the product (e.g., sausage) formulations, and during fermentation by starter cultures, the acyl glycerols release the acid and reduce the time required to achieve the target acidity without having to heat the product. This has the advantage that the product quality will be preserved.

Acyl glycerol may be used to enhance fermentation processes in fermented sausage manufacturing as described below.

Meat trimmings are purchased from a supplier, blended to target 10% fat, and ground through a 12.7-mm plate. Trimmings are then ground a second time (4.76 mm) and placed into a reverse action mixer (Model A-80, Koch, Kansas City, MO). The ground trimmings are subsequently mixed for 1 min with a typical fermented sausage seasoning blend including the following: 0.25% sodium nitrite (156 parts per million [ppm]) and 0.05% sodium erythorbate (539 ppm), along with the required quantity of the acyl glycerols. The batter is then inoculated with 10 g of thawed Pediococcus acidilacti or similar starter culture (Kerry, Rochester, MN) diluted in 236 mL of distilled water (23° C.±2° C.) and mixed for an additional 2 min. The prepared batter is then placed into a vacuum stuffer (Vemag Robot 500, Reiser, Canton, MA), stuffed into fibrous mahogany casings of 5.08 cm in diameter (11 chubs) (Visko Teepak, Kenosha, WI), and clipped. All chubs are then hung on a smoke cart and placed in an Alkar smokehouse (Model 8770-4-12000, Lodi, WI). Sausages are allowed to ferment at 43.3° C. dry bulb with 85% relative humidity until the target endpoint pH is achieved. After fermentation, the dry bulb temperature is increased to 62.8° C. with a relative humidity of 85% for 30 min and is then increased again to 73.9° C. with 90% relative humidity for the remainder of the cooking cycle, and the sausages are cooked to an internal temperature of 43.3° C., 48.9° C., and 54.4° C. followed by ice bath chilling. The product is then processed similar to the existing fermented sausage manufacturing process.

### Example 4

This Example further demonstrates the effect of triacetin on the microbial shelf life of ground meat products. Traditionally, ground meat products are stored at 0° C. during processing, transportation and storage prior to display to control microbial growth and extend microbial shelf life. However, most of such products must be displayed at retail for consumers to select the product. The temperatures of the display case may be higher than the desired 0° C., and may be up to 7 or 10° C. These temperatures are considered abusive storage temperatures and extended storage time at these temperatures will severely lower the microbial shelf life of the meat products, especially the ground products, regardless of the type—beef, pork or chicken.

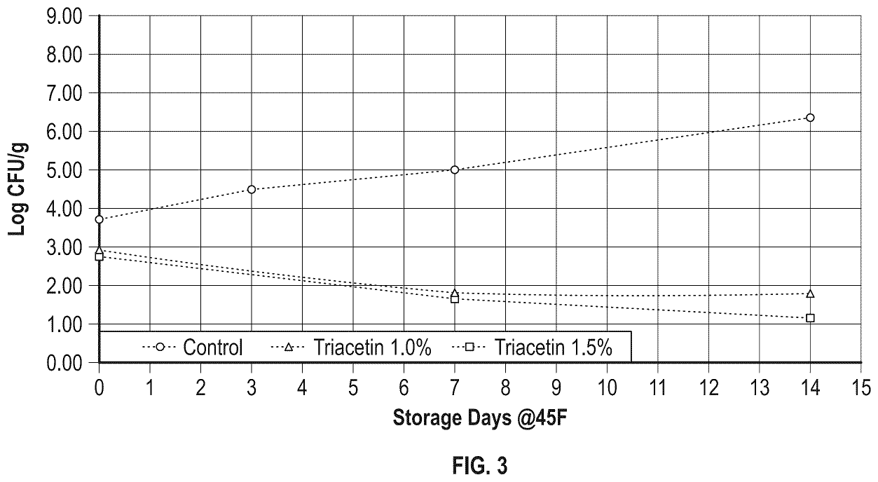

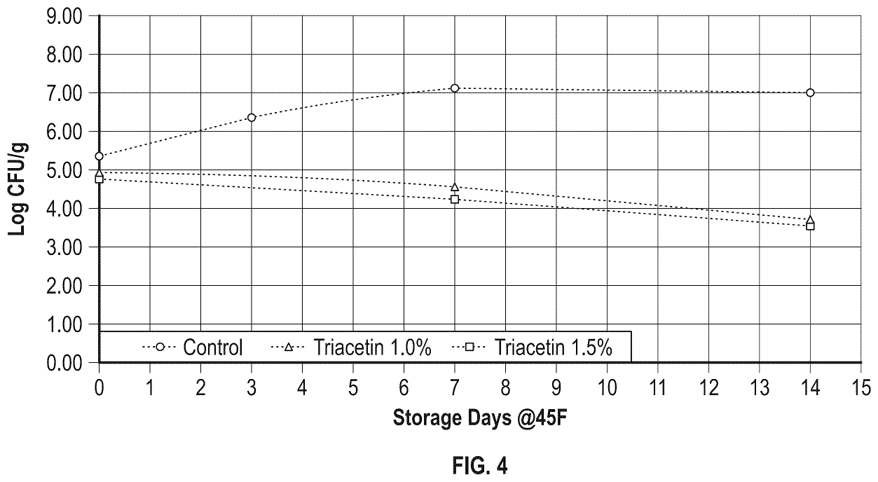

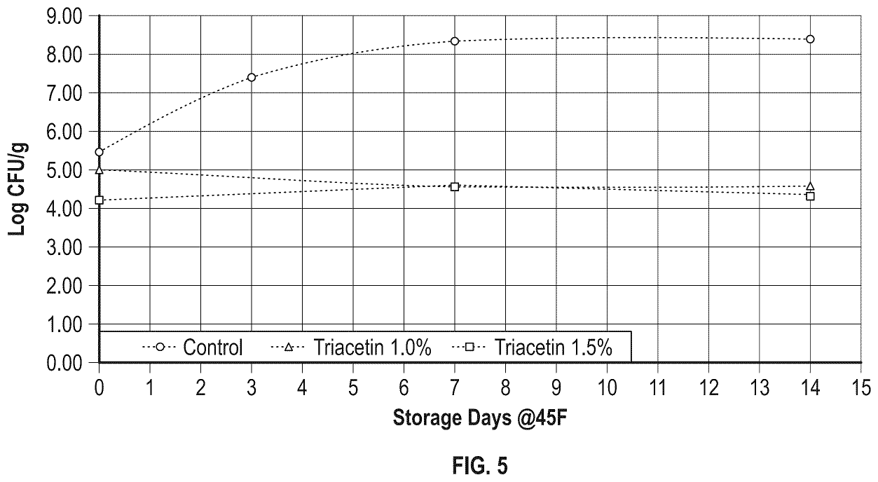

The microbial growth in ground beef containing 1.0% and 1.5% triacetin was evaluated. Beef chuck roll was obtained from a wholesale store, coarse ground and divided into three equal portions. One portion was considered control (triacetin not added), while the two other portions received a spray of triacetin at 1.0% or 1.5% by weight, separately. The meat was mixed manually and then fine ground to ⅛ inch and packaged on trays (1 lb) and overwrapped with Saran wrap as is packaged in commercial operations. The trays containing the ground beef were stored in a cooler set at 7.2° C. Three independent replications were performed with different beef chuck roll. Total aerobic plate counts (APCs) were determined on days 0, 7 and 14 days of refrigerated storage at 7.2° C. and reported as log CFU/g. The same experiment was performed for ground pork and ground chicken. Results are given in FIGS. 3-5, which show microbiological quality (APC) of ground beef, pork, and chicken, respectively containing triacetin during refrigerated storage at 45° F.

The general microbial population (APC) for ground beef (Control), without any triacetin was 3.73±0.30 log CFU/g, while that of ground beef containing triacetin at 1.0 and 1.5% was 2.93±0.18 and 2.76±0.14, respectively on day 0 (day of preparation). Storage at 7.2° C. for days 3, 7 and 14 resulted in general microbial populations of 4.49±0.20, 5.05±0.35 and 6.36±0.13 log CFU/g, respectively. Addition of triacetin at 1.0% in ground beef reduced general microorganisms (APCs), with a general microbial population (APCs) of 1.82±1.14 and 1.80±0.12 log CFU/g on day 7 and 14, respectively during abusive refrigerated storage. Similarly, addition of triacetin to ground beef at 1.5% resulted in reduction in general microbial population, with APCs of 1.70±1.26 and 1.18±0.15 log CFU/g on days 7 and 14, respectively during abusive refrigerated storage at 7.2° C. Emswiler et al. 1976 (Applied and Environmental Microbiology 31(6):826-830) reported initial general microbial population of 4.60 log CFU/g in fresh ground beef obtained from commercial processor. Storage under ideal conditions of refrigeration, at −1.7° C. resulted in an increase to 5.18 log CFU/g by day 15. However, the storage temperature in that case was ideal, whereas in the evaluation of triacetin described in the present Example, an abusive storage temperature of 7.2° C. was used. Even under this abusive storage temperature 7.2° C., the general microbial population decreased from initial population of 2.93 and 2.76 log CFU/g in ground beef containing 1.0 and 1.5% triacetin to 1.80±1.12 and 1.18±0.15 log CFU/g, respectively after 14 days.

The general microbial population (APC) of ground pork (Control, without triacetin) was 5.44±0.23 log CFU/g, while that of ground pork containing triacetin at 1.0 and 1.5% was 4.95±0.10 and 4.79±0.07 log CFU/g, respectively on day 0 (day of preparation). Storage at 7.2° C. for days 3, 7 and 14 resulted in general microbial populations of 6.45±0.07, 7.18±0.30 and 7.02±0.28 and log CFU/g, respectively. Storage of ground pork at 7.2° C. containing triacetin (1.0%) resulted in a reduction in APCs, to 4.58±0.10 and 3.71±0.10 log CFU/g on days 7 and 14. Similarly, greater reductions in APCs were observed in ground pork containing 1.5% triacetin and stored at 7.2° C. to 4.22±0.09 and 3.56±0.26 log CFU/g on days 7 and 14. As observed with ground beef, the storage temperature used in this evaluation is not ideal for meat storage, but even under abusive storage temperatures, a decline in general microbial population was observed in ground pork containing triacetin, regardless of triacetin concentration.

The general microbial population (APC) of ground chicken (Control, without triacetin) was 5.45±0.26 log CFU/g, while that of ground chicken containing triacetin at 1.0 and 1.5% was 5.01±0.42, 4.21±0.15 log CFU/g, respectively on day 0 (day of preparation). Storage at 7.2° C. for days 3, 7 and 14 resulted in growth of microbial populations to 7.39±0.06, 8.32±0.18 and 8.39±0.09 log CFU/g, respectively. Addition of triacetin at 1.0% in ground chicken resulted in controlling growth of general microbial population (APC) in ground chicken, with 4.51±0.54 and 4.57±0.40 log CFU/g, after 7 and 14 days, respectively when stored at 7.2° C. Similarly, addition of triacetin at 1.5% in ground chicken resulted in control of general microbial population, with 4.54±0.56 and 4.33±0.45 log CFU/g on days 7 and 14, respectively when stored at 7.2° C.

In all of the meat types (ground beef, ground pork and ground chicken), growth of general microbial flora was observed in Control (product without triacetin), with increases of 2.69±0.42, 1.57±0.18 and 2.99±0.29 log CFU/g, respectively by day 14, when stored at 7.2° C. However, addition of triacetin in ground beef, ground pork and ground chicken at 1.0% resulted in decreases in general microbial flora of 1.11±0.16, 1.24±0.06 and 0.43±0.07 log CFU/g, respectively when stored for 14 days at 7.2° C. Similar reductions in general microbial flora or minimal increases (<0.20 log CFU/g) were observed in ground meat (ground beef, ground pork and ground chicken) containing 1.5% triacetin after 14 days of storage at 7.2° C.

Addition of triacetin to ground meat products (ground beef, ground pork or ground chicken) resulted in significant increase in microbial shelf life of the ground meat products, with reduction in general microbial population observed during storage at abusive storage temperature of 45° F. (7.2° C.), whereas significant increase in general microbial population to greater than 7.00 log CFU/g observed within 14 days in meat product that did not contain triacetin.

### Example 5

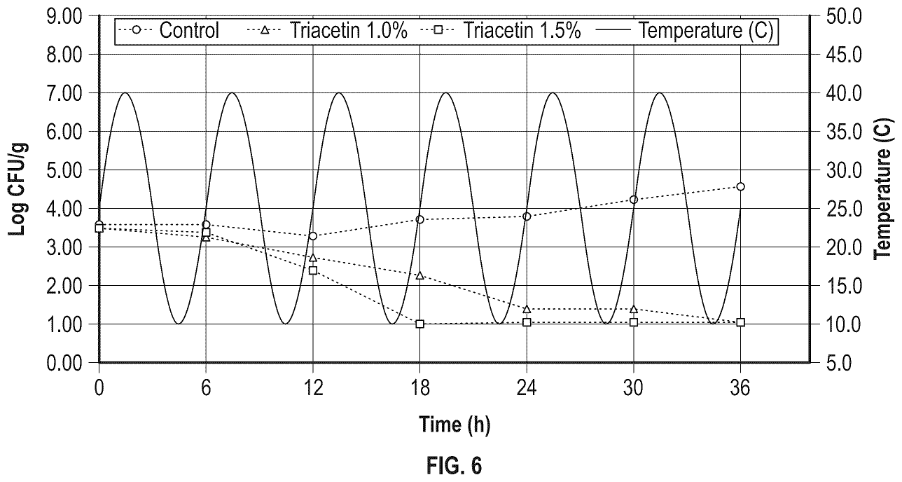

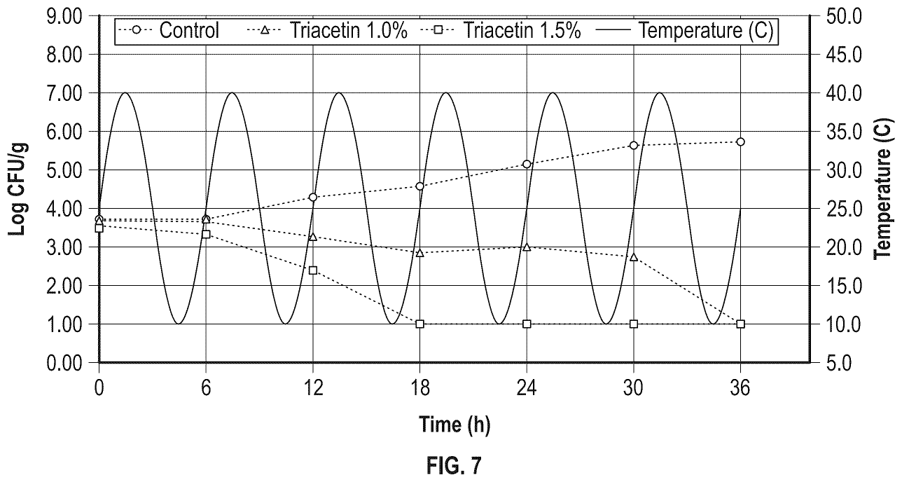

The foodborne pathogen growth in ground pork (Salmonella spp.) and ground chicken (Salmonella spp.) containing 1.0% or 1.5% of triacetin was evaluated. Ground pork was prepared from pork picnics, which were obtained from a wholesale store, coarse ground and divided into three equal portions. One portion was considered control (triacetin not added), while the two other portions received a spray of triacetin at 1.0% or 1.5% by weight, separately. The meat was mixed manually and then fine ground to ⅛ inch. The meat was packaged in 500 g portions into vacuum bags, vacuum packaged and stored frozen. Three independent replications were performed with different pork picnics. Similarly, for ground chicken, vacuum packaged chicken thighs were obtained from commercial wholesale store and processed similar to ground pork as described earlier. FIG. 6 and FIG. 7 show destruction of Salmonella in ground pork and ground chicken respectively containing triacetin during continuously varying temperatures.

Five-gram portions of the meat mixture representing each treatment were weighed into vacuum pouches (3-mil standard barrier polyethylene-nylon bag with a water vapor transmission rate of 10 g/liter/m²/24 h at 37.8° C. and 100% relative humidity and an oxygen transmission rate of 3,000 cm³/liter/m²/24 h at 23° C. and 1 atm) that were 2.5 by 3.0 in. (6.35 by 7.6 cm) (Prime Source, Kansas City, MO), and the pouches were vacuum sealed at 12 mbar (1.2 kPa) with a Multivac vacuum packaging machine and stored frozen at −20° C. until used. Samples were thawed overnight at 5° C. in a refrigerator before the experiment, and each pouch containing the meat was aseptically inoculated with 10 microliters of inoculum (E. coli O157:H7 for ground beef and Salmonella spp. for ground pork and ground chicken) to attain a final population of ca. 3.50-4.00 log CFU per g of meat.

The inoculated samples (in vacuum pouches) were placed in a programmable water bath with sinusoidal time-temperature profile between 10-40° C. for 36 h with a cycling time of 6 h/cycle. A programmable water bath with water circulation capabilities (AP15R-40-A118B, Polyscience, Niles, IL) was used to run the sinusoidal temperature profile.

The initial Salmonella spp. population in ground pork subsequent to inoculation was 3.56 log CFU/g. Subjecting the inoculated ground pork (control without triacetin) to sinusoidal abusive temperature profile (10° C. to 40° C. within 6 h, for 35 h) resulted in Salmonella spp. growth of 0.92 log CFU/g. However, subjecting the Salmonella inoculated ground pork containing triacetin at 1.0 and 1.5% resulted in a reduction in Salmonella spp. population of 2.51 and 2.58 log CFU/g, respectively after 36 h.

The initial Salmonella spp. population in ground chicken subsequent to inoculation was 3.71 log CFU/g. Subjecting the inoculated ground chicken (control without triacetin) to sinusoidal abusive temperature profile (10° C. to 40° C. within 6 h, for 35 h) resulted in Salmonella spp. growth of 2.01 log CFU/g. However, subjecting the Salmonella inoculated ground chicken containing triacetin at 1.0 and 1.5% resulted in reduction in Salmonella spp. population of 2.70 and 2.71 log CFU/g, respectively after 36 h.

Regardless of the meat type, Salmonella spp. growth occurred in ground pork or ground chicken when the meat (without triacetin) was subjected to abusive temperature conditions. Addition of triacetin at either 1.0% or 1.5% resulted in significant reduction in Salmonella population, regardless of the meat type (ground pork or ground chicken).

### Example 6

Fermented foods are a staple in human diet. These foods are prepared through the use of desired microbial growth and enzymatic conversions of food components. The fermented foods most commonly consumed include dairy products (cheese and yoghurt), vegetable products (sauerkraut and kimchi), cereal products (bread, sour dough) and meat products (pepperoni, salami, etc.).

Fermentation processes can take anywhere from 4.5 h to as long as 18 h or longer in some cases. Expediting the fermentation process or the acid production can decrease the processing time significantly for a producer, and consequently enhance productivity.

Refrigerated beef chuck roll (Institutional Meat Purchase Specifications #116A; USDA Select) was obtained from a wholesale store. The beef chuck roll was trimmed to remove excess fat. The meat was portioned into three 6 lb batches. Each batch was cut into approximately 1-inch pieces and ground using 20 mm plate. One batch did not receive any spray (control), the second batch received 0.5% triacetin and the third batch received 1.0% triacetin. The ground meat was placed in a reverse action mixer (Model A-80, Koch, Kansas City, MO) and mixed for 1 min and a typical summer sausage seasoning blend including the following: 2% salt (Mortons, Chicago, IL); 1.0% dextrose; 0.25% sodium nitrite (156 parts per million [ppm]); 0.13% black pepper, white pepper, and garlic powder; 0.06% ginger, coriander, and mustard; and 0.05% sodium erythorbate (539 ppm).

The meat batter was then inoculated with 10 g of thawed Pediococcus acidilacti starter culture (SAGA200) diluted in 236 mL of distilled water (23±2° C.) and mixed for an additional 2 min.

Each treatment was placed in vacuum bag and sealed. The batter (all treatments) was transferred to a water bath set at 32° C. A portion (25 g) of the meat from each bag (treatment) was removed and pH of the meat was determined using a pH meter at 3 h intervals for a total of 12 h.

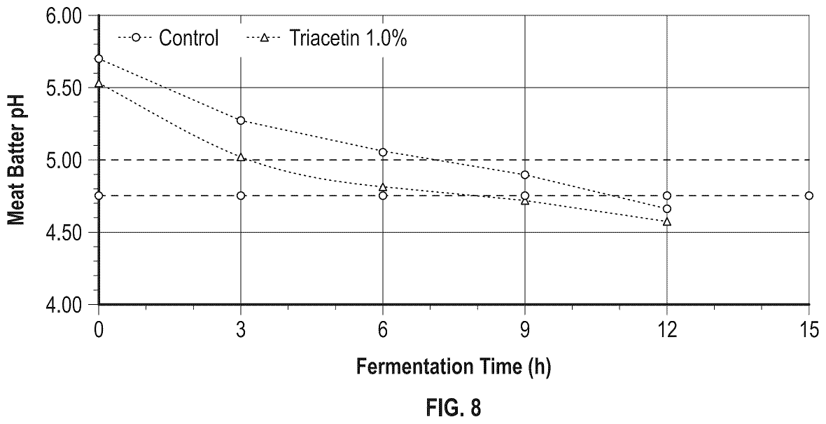

FIG. 8 shows pH decline in meat batter containing triacetin during fermentation at 32° C. The initial pH of meat batter (control, without any triacetin) was 5.69±0.03. Addition of triacetin at 0.5% and 1.0% resulted in a lower pH value, with 5.62±0.01 and 5.53±0.02, respectively. Incubation of the meat batter at 33° C. resulted in gradual decrease in pH in control batter, with pH 5.00 attained within 7 h, while the batter containing 1.0% triacetin achieved the pH 5.00 within 3 h. A further decline in pH to 4.75 was attained within 10.5 h in control meat batter, while the same pH was attained within 7.0 h in meat batter containing 1.0% triacetin. Regardless of the target pH, addition of triacetin at 1.0% resulted in lower pH in the meat batter during fermentation.

A reduction in fermentation time means reduced production time for fermented meat processors. This reduction in fermentation time means increased production capacity and reduced production costs without any capital investment in the infrastructure for the fermented meat processors.

### Example 7

This Example demonstrates the effect of triacetin on the extension of shelf life of fruits. Strawberry (Fragaria ananassa) is among the most perishable fruits and is vulnerable to physical injuries and fungal invasion. Strawberries deteriorate during storage as a result of decay along with physical senescence and dehydration. Botrytis cinerea and Rhizopus sp. are the two most frequently reported decay fungi responsible for microbial deterioration of strawberries. Botrytis sp. has been studied intensively because of their association with serious rot problems of berries and table grapes. Rhizopus rot is most prevalent on ripe or near-ripe berries. Cladosporium rot fungus is generally a wound pathogen prevalent on overripe and senescent fruit, particularly in storage near the end of the fruit integrity.

Potential approaches to extend the storage stability of these perishable commodities include application of edible coatings on the surface followed by cold storage. Edible coatings can be used as a protective barrier to reduce respiration and the transpiration rate through fruit surfaces, retard microbial growth and color changes, and improve physical integrity by reinforcing the tender skin structure.

A limited number of coating studies on fresh strawberries have been published, including using chitosan, starch-based polysaccharides, whey protein and calcium caseinate-based proteins, and pullulan. Other popular edible coating formulations were polysaccharide-based or protein-based polymers incorporated with chemical fungicides, such as sorbate and benzoate.

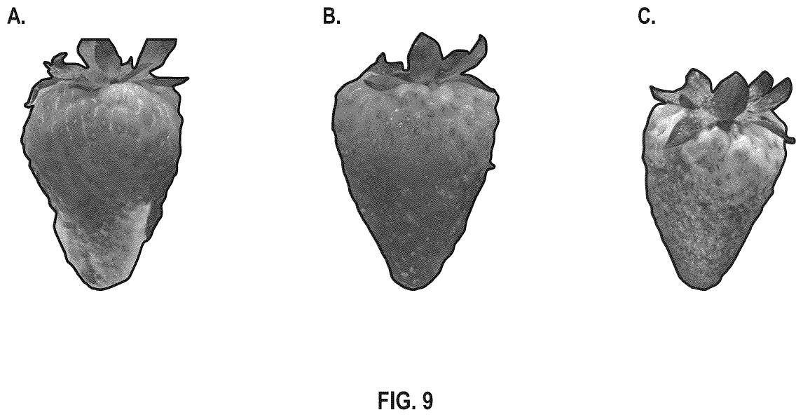

FIGS. 9A-C show strawberry fruit containing mold (panel A), mold cleaned with water and strawberry sprayed with triacetin (panel B), and triacetin sprayed strawberry stored at 21° C. for 4 days, indicating inhibition of mold (panel C). FIG. 9A shows an individual strawberry from a package of strawberries obtained from retail store on Day 0. The strawberry from panel A was washed with tap water to remove the visible mold (fungus) and sprayed with triacetin (1% by weight of the strawberry) on the surface (Day 0); the result after washing and spray is shown in FIG. 9B. FIG. 9C shows the strawberry from panel B following storage at 21° C. (room temperature, which is considered to be an abusive temperature; strawberries are typically stored under refrigeration to slow mold/fungal growth) for 4 days.

Strawberries were obtained from a retail grocery store. Strawberries from one box were removed and placed on an aluminum tray and sprayed with triacetin. The weight gain (triacetin) of strawberries after spray was 1.4%. The strawberries were placed in the original container and stored along with a non-sprayed control container with strawberries at 25° C. to accelerate mold growth and visible spoilage. After 4 days of storage at 25° C., significant mold growth was observed on control strawberries (non-sprayed), while the strawberries sprayed with triacetin did not show evidence of mold growth and mold spoilage.

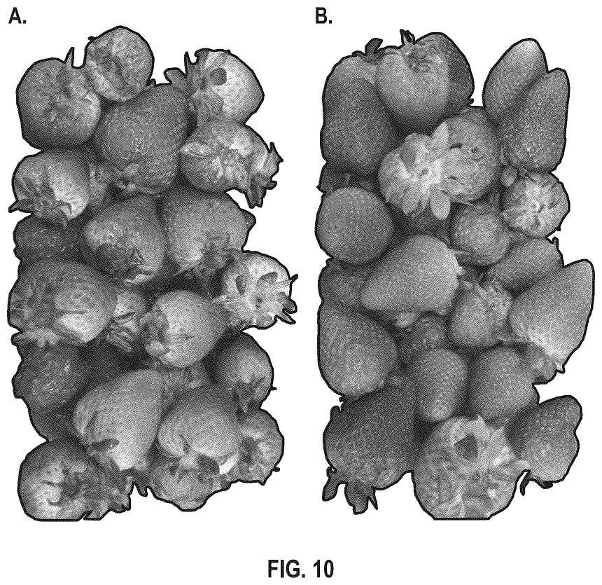

FIGS. 10A-B show ripe strawberries obtained from a retail supermarket. The strawberries in FIG. 10A were used as control (no spray), while the strawberries in FIG. 10B were sprayed with triacetin (1% by weight) on strawberry surfaces uniformly. The pictures were obtained on Day 0 to show changes during subsequent abusive storage.

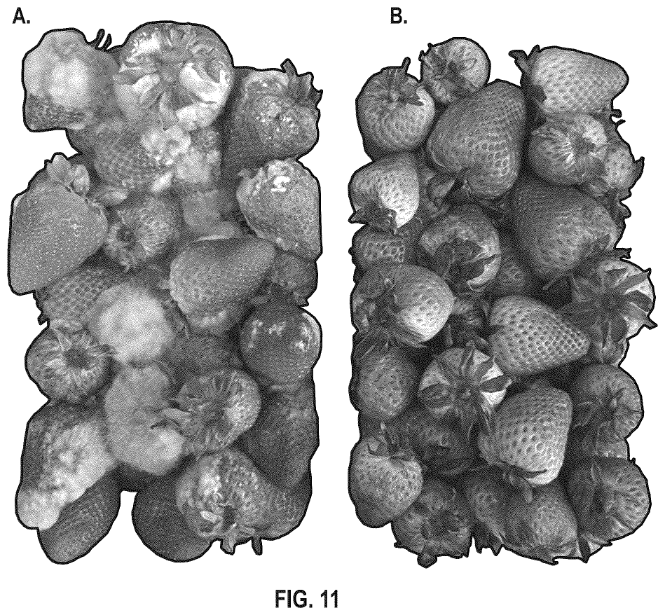

FIGS. 11A-B show inhibition of spoilage mold on ripe strawberries obtained from a retail supermarket and stored at 21° C. for 4 days. The strawberries in FIG. 11A are without triacetin spray (control) and the strawberries in FIG. 11B are with triacetin spray (indicating inhibition of mold).

### Example 8

This Example describes the preparation of mixed triacyl glycerols (s-TAGs) useful in some embodiments of the invention. The glycerol molecule contains three binding sites for the esterification—1, 2 and 3 (see Formula 2 above). Any and all of the three can be esterified with specific organic acids. For example, if the desired function is to control bacterial spoilage and also spoilage due to mold growth, one or two of the binding sites can be used to esterify with propionic acid, benzoic acid or sorbic acid. This “tailoring” allows for developing and delivering specific functionality (in this case, both bacterial as well as mold growth and spoilage).

The esterification sites 1, 2 and 3 can be selectively esterified with any of the acids, including the organic acids (formic, acetic, propionic, lactic, etc.) or other acids (sorbic, benzoic, etc.) at any and all esterification sites (1, 2 and/or 3) to tailor the triacyl glycerol to specific purpose or application (e.g., to control bacterial and/or mold growth).

Alternatively, triacetin can be combined at desired proportions with tripropionin (glycerol esterified with three molecules of propionic acid) or other acyl glycerols.

The proportions of the mixtures and the specifics (triacetin:tripropionin) of the mixtures will depend on the desired functionality and also the proportions and concentrations desired or required in the finished product for the functionality.

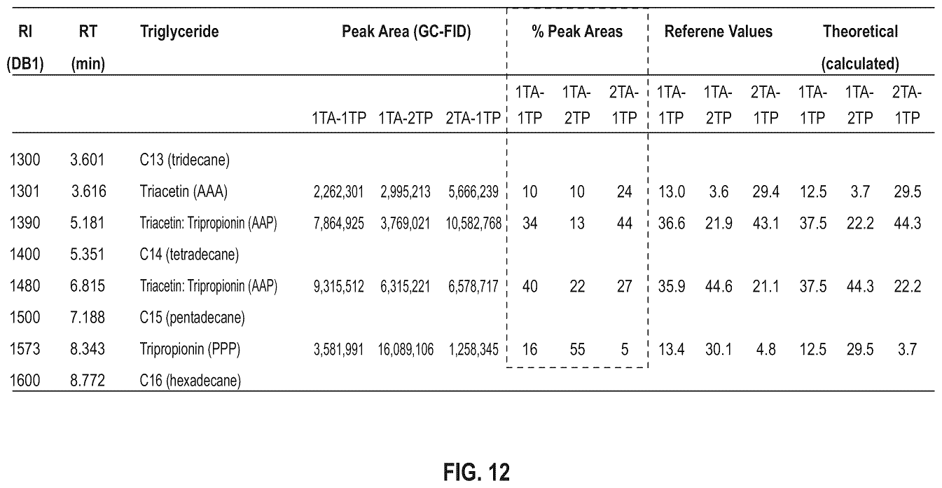

Mixtures of triacyl glycerols containing different short chain fatty acids (acetic and propionic acids; s-TAGs) were produced as examples. The s-TAGs were prepared by the NaOCH₃ catalyzed interesterification of model reactions performed with different mole ratios of Triacetin, and Tripropionin. All reagents were reagent grade having greater than 98% purity and all were purchased from Sigma Aldrich Milwaukee, WI. The mole ratios of each reactant (see FIG. 12) were weighed in a 3 neck round bottom flask and reacted under the following conditions (1) stirred and heated to 120-130° C. under slight vacuum for 30 minutes (2) a 2% (w/w) of NaOCH₃ catalyst was added and the reaction mixture was heated at 88-90° C. for 3 hours (3) added 0.3% of 85% H₃PO₄ to neutralize the catalyst after the reaction went to completion and (4) liquid products were then purified by filtration for analysis. The reaction products were then characterized by GC-FID. The weight % of the s-TAGs found were compared to the amount predicted using the statistical randomized interesterification reaction model.

Mixed s-TAGs containing acetic (A) and propionic (P) acids at different locations on the triglyceride molecule (0=no acid at that position) and different proportions of these triglyceride mixtures were produced (FIG. 12). Mixture (1) A-0-P (10%), P-A-P (10%) and A-P-A (24%), (2) A-0-P (34%), P-A-P (13%) and A-P-A (44%), (3) A-0-P (40%), P-A-P (22%) and A-P-A (27%), (4) A-0-P (16%), P-A-P (55%) and A-P-A (5%).

Similarly, any different proportions of s-TAGs can be prepared with acetic, propionic, butyric, citric and lactic acids, for example. Further, these s-TAGs can be further purified to contain only the specific s-TAG, for example P-A-P or A-P-A or other short chain fatty acids in place of the acetic (A) and propionic (P) acids used in this experiment. These specific purified s-TAGs can be used for specific purposes, for example to enhance the mold inhibition on a food product, along with inhibition of general spoilage microorganisms and the balance of these two important functions.

### Example 9

This Example demonstrates the microbial inhibitory activity of s-TAGs. The microbial growth in ground turkey containing 1.0% of triacetin (TA), TA-TP mixture 1 (2TA:1TP), TA-TP mixture 2 (1TA:2TP), and tripropionin (TP) was evaluated. Vacuum packaged ground turkey was obtained from a wholesale store and divided into five equal portions of approximately 500 g each. One portion was considered control (no addition of antimicrobials), while the other portions received a spray of each of the antimicrobials (1.0% by weight). The meat was mixed in a bowl mixer, vacuum packaged and stored frozen. Five-gram portions of the meat mixture representing each treatment were weighed into vacuum pouches (3-mil standard barrier polyethylene-nylon bag with a water vapor transmission rate of 10 g/liter/m²/24 h at 37.8° C. and 100% relative humidity and an oxygen transmission rate of 3,000 cm³/liter/m²/24 h at 23° C. and 1 atm) that were 2.5 by 3.0 in. (6.35 by 7.6 cm) (Prime Source, Kansas City, MO), and the pouches were vacuum sealed at 12 mbar (1.2 kPa) with a Multivac vacuum packaging machine and stored frozen at −20° C. until used. Samples were thawed overnight at 5° C. in a refrigerator before the experiment, and each pouch containing the meat was aseptically inoculated with 10 microliters of inoculum (Salmonella spp.) to attain a final population of ca. 2.75 log CFU per g of meat.

The inoculated samples (in vacuum pouches) were placed in a programmable water bath with sinusoidal time-temperature profile between 10-40° C. for 36 h with a cycling time of 6 h/cycle. Programmable water baths with water circulation capabilities (AP15R-40-A118B, Polyscience, Niles, IL) were used to run the temperature profiles.

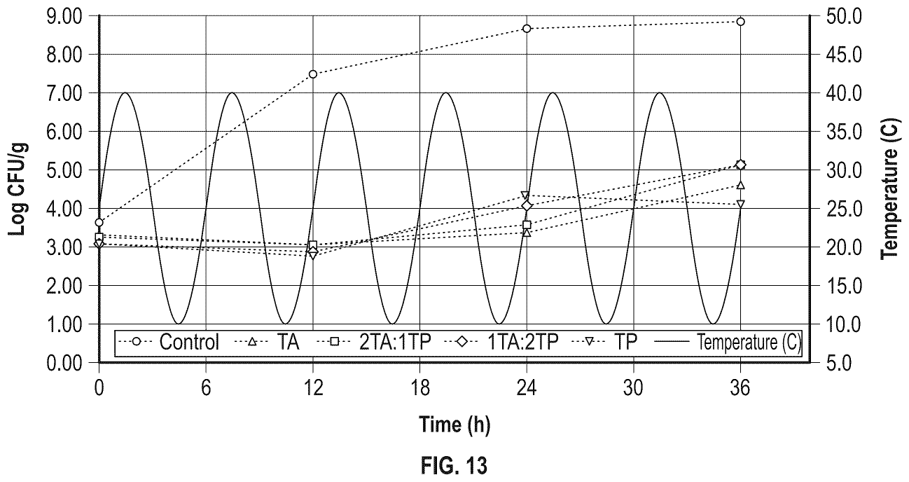

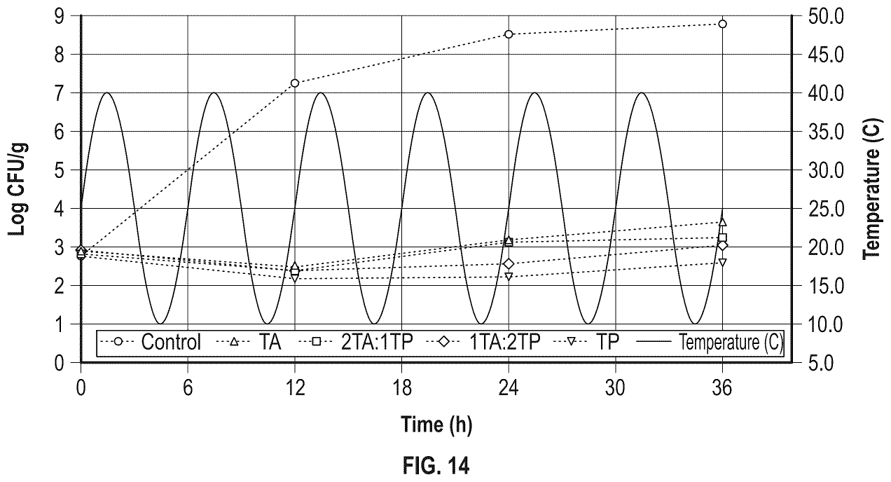

FIG. 13 shows control of APCs in ground turkey containing triacetin (TA), tripropionin (TP), and mixtures thereof during continuously varying temperatures. FIG. 14 shows control of Salmonella in ground turkey containing triacetin (TA), tripropionin (TP), and mixtures thereof during continuously varying temperatures.

The initial general microbial population (APC) in ground turkey was 3.67 log CFU/g. Subjecting the ground turkey to sinusoidal temperature profile to replicate extreme temperature abuse in a commercial setting for 36 h resulted in microbial growth, with final population of 8.85 log CFU/g, a growth of 5.18 log CFU/g from initial population. Similarly, subjecting the ground turkey containing 1% of 1.0% of triacetin (TA), TA-TP mixture 1 (2TA:1TP), TA-TP mixture 2 (1TA:2TP), and tripropionin (TP) resulted in a growth of 1.33, 1.89, 2.05 and 1.05 log CFU/g, indicating significant inhibition of general microbial population (APC).

Similarly, the initial Salmonella population in the inoculated ground turkey meat was 2.74 log CFU/g, with an increase to 8.80 log CFU/g (6.06 log CFU/g growth) observed in 36 h when subjected to sinusoidal temperature profile between 10-40° C. for 36 h with a cycling time of 6 h/cycle. Similarly, subjecting ground turkey inoculated with Salmonella spp. and containing 1% of 1.0% of triacetin (TA), TA-TP mixture 1 (2TA:1TP), TA-TP mixture 2 (1TA:2TP), and tripropionin (TP) resulted in Salmonella growth of 0.78, 0.43, 0.10 and −0.21 (reduction) log CFU/g, indicating significant inhibition of Salmonella spp. in ground turkey during abusive temperature conditions.

While there have been shown and described fundamental novel features of the invention as applied to the preferred and illustrative embodiments thereof, it will be understood that omissions and substitutions and changes in the form and details of the disclosed invention may be made by those skilled in the art without departing from the spirit of the invention. Moreover, as is readily apparent, numerous modifications and changes may readily occur to those skilled in the art. For example, various features and structures of the different embodiments discussed herein may be combined and interchanged. Hence, it is not desired to limit the invention to the exact construction and operation shown and described and, accordingly, all suitable modification equivalents may be resorted to falling within the scope of the invention as claimed. It is the intention, therefore, to be limited only as indicated by the scope of the claims appended hereto.

1. A method of inhibiting growth of foodborne microorganisms in a food product, comprising adding to the food product an acyl glycerol comprising one or more short chain fatty acids having antimicrobial activity, wherein the method provides free forms of said acids in the food product on demand responsive to the growth of the microorganisms in the food product.

2. The method of claim 1, wherein at least one of the short chain fatty acids is selected from the group consisting of formic acid, acetic acid, propionic acid, lactic acid, butyric acid, iso-butyric acid, valeric acid, iso-valeric acid, and 2-methylbutyric acid.

3. The method of claim 1, wherein at least one of the short chain fatty acids is benzoic acid, sorbic acid, or citric acid.

4. The method of claim 1, wherein the acyl glycerol is a triacyl glycerol (TAG).

5. The method of claim 1, wherein the acyl glycerol is triacetin, diacetin, or monoacetin.

6. The method of claim 1, wherein a concentration of the acyl glycerol is about 0.05% to about 5% by weight of the food product.

7. The method of claim 1, wherein a concentration of the acyl glycerol is about 0.5% to about 2% by weight of the food product.

8. The method of claim 1, wherein the acyl glycerol is added to the food product as a spray.

9. The method of claim 1, wherein the acyl glycerol is added to the food product in combination with one or more additional agents.

10. The method of claim 9, wherein the one or more additional agents comprise one or more bactericidal antimicrobials, bacteriostatic antimicrobials, anti-mycotics, acidifiers, bacteriocins, antioxidants, chelating agents, antifoam agents, emulsifiers, or flavoring agents.

11. The method of claim 10, wherein the bactericidal antimicrobials are selected from the group consisting of organic acids, PAA, ASC, ACS, and LAE; the bacteriostatic antimicrobials are selected from the group consisting of sodium or potassium salts of organic acids, and hops acids; the organic acids comprise formic, acetic, propionic, citric, and lactic acids; and the antioxidants are selected from the group consisting of BHA, BHT, TBHQ, PG, rosemary extract, tocopherols and Vitamin E extracts, ascorbic acid, plant derived polyphenols, liquid smoke, and liquid smoke extracts and fractions.

12. The method of claim 1, wherein the microorganisms comprise at least one of spoilage bacteria, pathogenic bacteria, molds, and yeasts.

13. The method of claim 1, wherein the acyl glycerol comprises at least two different short chain fatty acids.

14. The method of claim 1, wherein the acyl glycerol comprises a mixture of two or more different acyl glycerols.

15. The method of claim 14, wherein the acyl glycerol comprises triacetin in combination with tripropionin.

16. The method of claim 1, wherein the method further comprises adding to the food product an enzyme capable of releasing the free forms of said acids.

17. The method of claim 1, wherein the food product comprises a meat product.

18. The method of claim 1, wherein the food product comprises fresh fruit.

19. A method of accelerating fermentation in a food product, comprising adding to the food product an acyl glycerol comprising one or more short chain fatty acids having antimicrobial activity; and adding to the food product a fermentation starter culture, wherein the method provides free forms of said acids in the food product as the acyl glycerol breaks down, thereby reducing time to reach a target pH as compared to a control without the acyl glycerol added.

20. The method of claim 19, wherein the food product comprises a dairy product, a vegetable product, a cereal product, or a meat product.

21. A composition for inhibiting growth of foodborne microorganisms and/or accelerating fermentation in a food product, the composition comprising an acyl glycerol comprising two or more different short chain fatty acids having antimicrobial activity.

22. A composition for inhibiting growth of foodborne microorganisms and/or accelerating fermentation in a food product, the composition comprising a mixture of two or more different acyl glycerols, each acyl glycerol comprising one or more short chain fatty acids having antimicrobial activity.
